(19) United States
(12) Patent Application Publication
(10) Pub. No.: US 2012/0311932 A1
(43) Pub. Date: Dec. 13, 2012

(54) GLOVEBOX SAFETY APPARATUS AND SYSTEM

(75) Inventors: MICHAEL EDWARD COURNOYER, Los Alamos, NM (US); JULIO MARCO CASTRO, Pojoaque, NM (US); XAVIER JULIAN SAENZ, El Paso, TX (US)

(73) Assignee: LOS ALAMOS NATIONAL SECURITY, LLC, LOS ALAMOS, NM (US)

(21) Appl. No.: 13/493,870

(22) Filed: Jun. 11, 2012

Related U.S. Application Data
(60) Provisional application No. 61/495,532, filed on Jun. 10, 2011.

(51) Int. Cl. B25J 21/02; E06B 5/18; E06B 5/16; E06B 5/10

(52) U.S. Cl. 49/13; 312/1

(57) ABSTRACT

A preferred system for ensuring the safety of a glovebox can include a glovebox configured for handling a sensitive material and comprising a pair of ports adjacent to a working cavity; a pair of gloves connected to the pair of ports and extending into the working cavity; and a plug removably connectable to one of the pair of ports. In preferred variations, the plug can include a protective material, a removable handle, and a shielding cavity. In alternative variations, the plug can also include a tamper indicating device to ensure that the plug, once engaged into the port, is not removed without proper authority or permission.

### PRIORITY CLAIM

The present application claims priority to U.S. Provisional Patent Application Ser. No. 61/495,532, entitled “Fire Shield Port Plug” and filed on 10 Jun. 2011, the entirety of which is incorporated herein by this reference.

### STATEMENT REGARDING FEDERAL RIGHTS

The United States government has rights in this invention pursuant to Contract No. DE-AC52-06NA25396 between the United States Department of Energy and Los Alamos National Security, LLC for the operation of Los Alamos National Laboratory.

### TECHNICAL FIELD

The invention generally relates to the field of industrial safety and security, and more particularly to the safety and security of glovebox apparatuses used in the nuclear, pharmaceutical, biomedical, chemical, semiconductor, and other research, development, and manufacturing industries.

### BACKGROUND AND SUMMARY

Gloveboxes are used to facilitate the handling or control of hazards and protect the worker by physically isolating the hazard inside an enclosure while allowing hands-on work to be performed through gloveports. Fire hazards in gloveboxes range from unmitigated fire propagation within the glovebox to special hazards (e.g. chemical, biological and nuclear hazards).

Conventional gloveboxes are fabricated from various materials depending upon the particular application of the glovebox. Materials widely used for fabricating gloveboxes include aluminum, carbon steel, stainless steel, steel painted with acid resistant paints, chrome plating, “Plexiglass” and plywood. A glovebox is generally provided with a plurality of glove ports having flexible, impervious gloves fitted thereto for reaching into the enclosure and working upon or with the confined materials. Plutonium and other nuclear materials require a high degree of confinement and continuous control in nuclear research laboratories because of their very high radiotoxicity. To prevent uncontrolled release of these material gloveboxes are used to confine plutonium during laboratory work. Gloveboxes are defined as an absolute barrier, i.e., providing sealed enclosures. Gloveboxes used for radioactive materials are maintained at a lower pressure than the surrounding atmosphere, so that microscopic leaks result in air intake rather than hazard outflow.

Externally penetrating radiation affects cells directly. External exposures may be fairly uniform over the whole body (external dose) or non-uniform, i.e., primarily focused on a limited body location (extremity dose). External and extremity dose is controlled by minimizing time, maximizing distance, using shielding, and using source reduction, collectively referred to as low as reasonably achievable (ALARA) measures. Excess external dose can cause cancer and benign tumors in some organs. Cancers induced by radiation do not have a threshold level of dose. Nevertheless, to minimize the risks of biological effects associated with radiation, the U.S. Department of Energy (DOE) has established an external whole body dose limit of 5 rem/yr. Excess extremity dose exhibits deterministic effects down to a certain threshold below which (by consensus) radiation is not considered to be harmful. For extremities, the DOE has established an extremity dose limit of 50 rem/year. Unfortunately, a gloveport (with a glovebox glove in it) is potentially susceptible to fire and can contribute to a glovebox workers external dose.

Accordingly, preferred embodiments of the present invention can include a plug, sealer, or cap that removably engages with the gloveport of a glovebox. As described below, a preferred system can include a glovebox configured for handling a sensitive material and include at least a pair of ports adjacent to a working cavity; a pair of gloves connected to the pair of ports and extending into the working cavity; and a plug removably connectable to one of the pair of ports. Preferably, the plug can include a protective material, a removable handle, and a shielding cavity. These and other aspects, advantages, and salient features of the preferred embodiments of the present invention are described in detail below with reference to the following Figures.

### BRIEF DESCRIPTION OF THE FIGURES

FIG. 1 is a perspective view of a glovebox system in accordance with a preferred embodiment of the present invention.

FIG. 2 is a plan view of a glovebox safety system in accordance with a preferred embodiment of the present invention.

FIG. 3 is an exploded view of a glovebox safety apparatus in accordance with another preferred embodiment of the present invention.

FIG. 4 is a plan view of a selected portion of the glovebox safety apparatus of the preferred embodiment.

FIG. 5 is a cross-sectional view of a selected portion of the glovebox safety apparatus of the preferred embodiment.

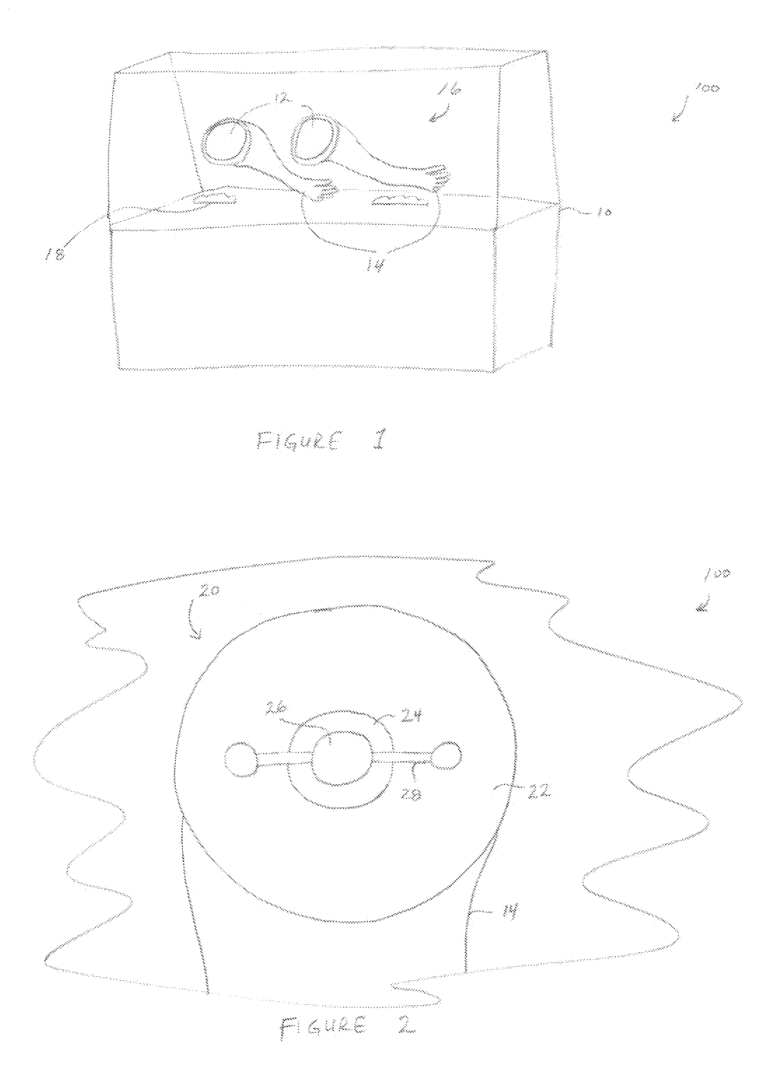

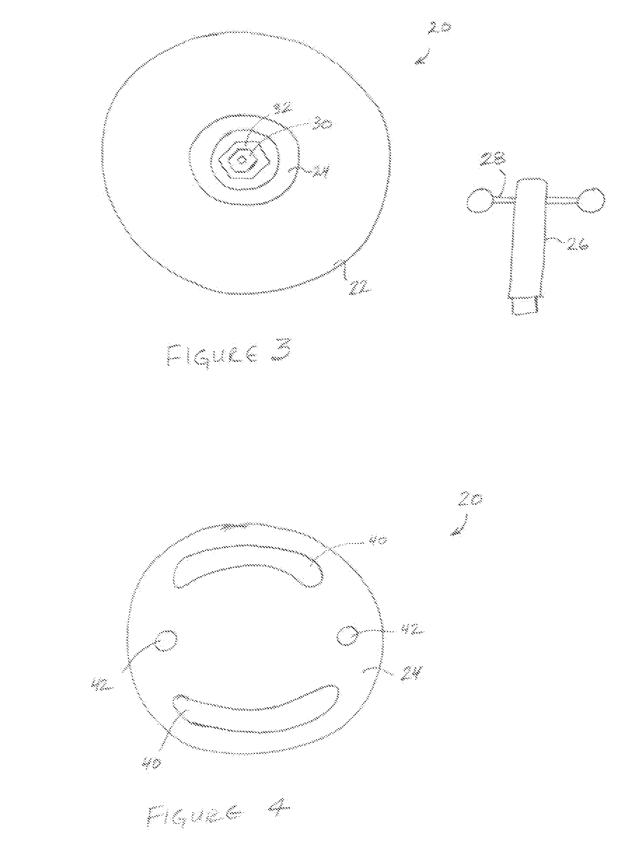

### DETAILED DESCRIPTION OF THE PREFERRED EMBODIMENTS

The following description of the preferred embodiments of the present invention and variations thereof is made with reference to the figures and one or more illustrative example configurations and/or implementations, the purpose of which is to permit one of ordinary skill in the art to make and use the present invention. Those of skill in the art will appreciate that the scope of the present invention is defined exclusively by the following claims.

As shown in the FIGURES, a system 100 and apparatus 20 of the preferred embodiment can include a glovebox 10 configured for handling a sensitive material 18 and comprising a pair of ports 12 adjacent to a working cavity 16; a pair of gloves 14 connected to the pair of ports 16 and extending into the working cavity 16; and a plug 22 removably connectable to one of the pair of ports 12. As described in detail below, the plug 22 preferably includes one or more of a protective material, a removable handle, and/or a shielding cavity. The system 100 and apparatus 20 preferably function to permit the selective and safe enclosure of one or more ports 12 adjacent the working cavity 16 of a glovebox 10 in order to prevent any unintended transmission of dangerous or sensitive material 18 outside of the glovebox 10. Furthermore, the preferred system 100 and apparatus 20 can preferably function to prevent the spread of fire in/out of the glovebox 10 and thereby protect one or both of the contents of the glovebox 10 and any users/workers located outside the glovebox 10.

In use, the system 100 and apparatus 20 of the preferred embodiment can function in the inspection, maintenance, assembly, experimentation, manufacture, diagnosis, and/or handling of any suitable material, such as for example biological materials, chemical materials, and/or nuclear materials. The preferred system 100 and preferred apparatus 20 can be readily adapted for use in nuclear, pharmaceutical, biomedical, chemical, semiconductor, and other research, development, and manufacturing facilities. Preferably, the plug 22 can be engaged and removed from the glovebox 10 without removal of the gloves 14 and/or modification of the ports 12 or the working cavity 16.

As shown in the FIGURES, the preferred apparatus 20 can include a plug 22 composed of a protective material. As an example, the protective material can include a fire retardant material, such as aluminum, and/or a radiation shielding material, such as lead, borated silicone, or any other suitable radiation shield. In one example configuration, the plug 22 can be composed entirely of aluminum have include a shielding cavity 50 into which radiation shielding material is deposited. Alternatively, the plug 22 can be composed substantially entirely of aluminum save for any radiation shielding materials and/or fire retardant sealing members, such as for example sealing O-rings suitable for use in a glovebox 10 environment. Preferably, the plug 22 is substantially fire retardant as well as substantially resistive to different forms of radiation, such as alpha, beta, and neutron particle radiation as well as x-ray and gamma photon radiation. Any suitable combination of fire retardant and radiation shielding materials can be used in the composition of the plug 22 depending upon the types of sensitive materials being manipulated in the glovebox 10. Preferably, the plug 22 is disposable in nature such that it can be readily replaced and safely discarded if and when it is exposed to certain forms of radiation.

As shown in FIG. 3, a preferred plug 22 can further include a removable handle 28 that is selectively attachable to the plug 22 at a driven plate 24. Preferably, the handle 28 engages the driven plate 24 though a drive shaft 26, although any other suitable mechanical configuration or machinery can be used in the alternative. As shown, the preferred plug 22 can further include a nut 30 disposed within a hexagonal cavity 32 to which the drive shaft 26 is selectively engaged. Alternative arrangements can include additional and/or varying hardware geometries and configurations, i.e., varying shapes, sizes, geometries of the nut 30 and/or hexagonal cavity 32 configured to receive the drive shaft 26.

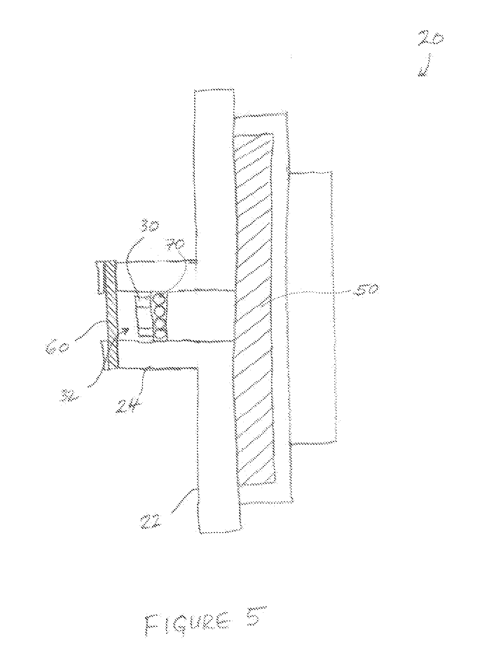

As shown in FIG. 4, the driven plate 24 portion of the plug 22 of the preferred embodiment can include one or more openings 40, 42 configured for fastening the driven plate 24 to the plug 22 and for permitting relative movement of the driven plate 24 relative to a set of bearings (not shown) in response to engagement of the removable handle 28. Rotation of the driven plate 24 by the removable handle 28 preferably causes the engagement/disengagement of the plug 22 at/to the glovebox 10. In alternative configurations, the driven plate 22 can be rotatably fastened to the plug 22 in any suitable fashion.

As shown in FIG. 5, the plug 22 of the preferred embodiment can include a removable handle 28. As shown, preferably the drive shaft 26 portion of the removable handle 28 can engage the plug 22 through a thrust bearing 70, the nut 30, and the hexagonal cavity 32. The preferred plug 22 can further include and/or define a shielding cavity 50 that is configured to host and/or receive one or more shielding materials of a predetermined nature. As an example, a plug 22 configured for use in a nuclear facility might include a shielding material adapted to absorb neutron, x-ray, and/or gamma radiation. As noted above, suitable shielding materials can include leaden materials as well as borated silicone, although any suitable material for attenuating radiation emanating from the working cavity 16 is suitable for use in the preferred plug 22.

As shown in FIG. 5, the preferred plug 22 can additionally include a tamper indicating device 60 configured to selectively mate with the plug 22 in order to prevent, hamper, deter, and/or detect tampering with the plug 22 when it is engaged to the glovebox 10. Suitable tamper indicating devices 60 can include a safety wire, a plastic or composite security seal, or any other member, article, or device adapted to prevent a user from inserting the removable handle 28 into the hexagonal cavity 32 in order to disengage the plug 22 from the port 12 of the glovebox 10. In other variations of the preferred embodiment, the tamper indicating device 60 can include a lock/key combination without which rotation of the plug 22 is not possible. Suitable lock/key combinations can include for example tumbler-based mechanisms, electro-mechanical locking mechanisms, opto-electronic locking mechanisms, biometric locking mechanisms, and/or any other suitable form of authentication and/or permission for installation and/or removal of the plug 22.

As a person skilled in the art will recognize from the previous detailed description and from the figures and claims, modifications and changes can be made to the preferred embodiments of the invention without departing from the scope of this invention defined in the following claims.

What is claimed is:

1. A system comprising:
a glovebox configured for handling a sensitive material and comprising a pair of ports adjacent to a working cavity;
a pair of gloves connected to the pair of ports and extending into the working cavity; and
a plug removably connectable to one of the pair of ports, the plug comprising a protective material, a removable handle, and a shielding cavity.

2. The system of claim 1, wherein the sensitive material comprises one of: biological material, chemical material, or nuclear material.

3. The system of claim 1, wherein the protective material comprises a fire retardant.

4. The system of claim 1, wherein the protective material comprises a radiation shield.

5. The system of claim 1, wherein the protective material comprises a fire retardant and a radiation shield.

6. The system of claim 1, further comprising borated silicone disposed within the shielding cavity.

7. The system of claim 1, further comprising a lock nut disposable on the plug subsequent to removal of the removable handle.

8. The system of claim 1, further comprising a tamper indicating device disposable in a handle port.

9. The system of claim 1, further comprising:
borated silicone disposed within the shielding cavity;
a lock nut disposable on the plug subsequent to removal of the removable handle; and
a tamper indicating device disposable in a handle port.

10. An apparatus comprising:
a plug removably connectable to a port of a glovebox, the plug comprising a protective material, a removable handle, and a shielding cavity;
borated silicone disposed within the shielding cavity;
a lock nut disposable on the plug subsequent to removal of the removable handle; and
a tamper indicating device disposable in a handle port.

11. The apparatus of claim 11, wherein the protective material comprises a fire retardant.

12. The apparatus of claim 11, wherein the protective material comprises a radiation shield.

13. The apparatus of claim 11, wherein the protective material comprises a fire retardant and a radiation shield.
